(19) United States
(12) Patent Application Publication
(10) Pub. No.: US 2013/0025273 A1
(43) Pub. Date: Jan. 31, 2013

(54) ELECTRIC BOOSTER

(71) Applicants: Yusuke NOZAWA, Atsugi-shi (JP); Tohma Yamaguchi, Kawasaki-shi (JP); Kentarou Ueno, Atsugi-shi (JP); Yukihiko Yamada, Atsugi-shi (JP); Daisuke Kojima, Atsugi-shi (JP)

(72) Inventors: Yusuke NOZAWA, Atsugi-shi (JP); Tohma Yamaguchi, Kawasaki-shi (JP); Kentarou Ueno, Atsugi-shi (JP); Yukihiko Yamada, Atsugi-shi (JP); Daisuke Kojima, Atsugi-shi (JP)

(21) Appl. No.: 13/558,756

(22) Filed: Jul. 26, 2012

(30) Foreign Application Priority Data
Jul. 28, 2011 (JP) 165549/2011

(51) Int. Cl. F15B 7/00

(52) U.S. Cl. 60/545

(57) ABSTRACT

Provided is an electric booster, including: an input member moved forward and backward by an operation of a brake pedal; a boosting member provided so as to be movable relative to the input member; an electric actuator for driving the boosting member; and a controller for controlling actuation of the electric actuator based on the movement of the input member, in which the controller executes changing control for changing a ratio of a movement amount of the boosting member to a movement amount of the input member to a smaller ratio before an output of the electric actuator increases to come into a full-load state in which the output of the electric actuator becomes equal to a maximum output by the forward movement of the input member.

### BACKGROUND OF THE INVENTION

1. Technical Field

The present invention relates to an electric booster which uses an electric actuator as a boost source, as a booster to be incorporated into a brake device for a vehicle such as an automobile.

2. Background Art

There exists an electric booster described in, for example, Japanese Patent Application Laid-open No. 2008-162482. The electric booster includes an input rod connected to a brake pedal, a booster piston provided externally to the input rod so as to be movable relative to the input rod, an electric motor for driving the booster piston, and a controller for controlling actuation of the electric motor in accordance with the movement of the input rod. A piston of the master cylinder is thrust by the input rod and the booster piston so as to apply a driving force of the electric motor. In this manner, a desired boost ratio is obtained for an operation of a brake pedal. For obtaining the desired boost ratio, a booster output can be changed with respect to an operation amount of the brake pedal by adjusting a relative displacement between the input rod and the booster piston. Therefore, various types of brake control such as boost control, brake-assist control, and regenerative cooperative control can be performed. Moreover, in case of a failure such as a failure of the electric motor, the input rod comes into contact with the piston of the master cylinder. Then, by directly pressing the piston of the master cylinder with the brake pedal, a braking function can be maintained.

However, the conventional electric booster described above has the following problem. The case where a driver firmly depresses the brake pedal while the vehicle is stopped is now supposed. When the driver depresses the brake pedal, the electric motor thrusts the booster piston by the forward movement of the input rod. In accordance with the operation amount of the brake pedal, a fluid pressure in the master cylinder is increased at a certain boost ratio. Then, when an output of the electric motor reaches a maximum output and then the thrust of the booster piston and a reaction force generated by the fluid pressure in the master cylinder equilibrate each other, the booster piston stops and cannot move forward anymore (in a full-load state). Thereafter, when the brake pedal is further depressed, only the input rod moves forward. Therefore, a pressure-rising speed of the brake fluid pressure is suddenly lowered by the stop of the booster piston as compared with that before the booster piston comes into the full-load state. Therefore, the reaction force of the brake pedal is suddenly reduced. Thereafter, when the brake pedal is further depressed, the input rod comes into contact with the booster piston in the stop state as in the case of the failure described above. The reaction force generated by the fluid pressure in the master cylinder entirely acts on the brake pedal through the input rod. As a result, the driver feels discomfort as if the brake pedal were suddenly locked.

### SUMMARY OF THE INVENTION

The present invention has been made to solve the problem described above and therefore, has an object to provide an electric booster which reduces a sudden change in reaction force to an operation of a brake pedal so as to improve a brake-pedal feeling.

In order to solve the problem described above, according to one aspect of the present invention, there is provided an electric booster including an input member moved forward and backward by an operation of a brake pedal, a boosting member provided so as be movable relative to the input member, for generating a brake fluid pressure in a master cylinder by forward movement of the boosting member, with which the input member comes into contact by the forward movement of the input member, an electric actuator for driving the boosting member, and a controller for controlling actuation of the electric actuator based on the movement of the input member, capable of changing a movement amount of the boosting member with respect to a movement amount of the input member to generate the brake fluid pressure in the master cylinder, in which the controller executes changing control for changing a ratio of the movement amount of the boosting member to the movement amount of the input member to a smaller ratio before an output of the electric actuator is increased to come into a full-load state in which the output of the electric actuator becomes equal to a maximum output by the forward movement of the input member.

### BRIEF DESCRIPTION OF THE DRAWINGS

In the accompanying drawings:

FIG. 1 is a schematic diagram illustrating a brake control device for an automobile, in which an electric booster according to an embodiment of the present invention is incorporated;

FIG. 2 is a circuit diagram illustrating a schematic configuration of a master-pressure control device of the brake control device illustrated in FIG. 1;

FIG. 3 is a block diagram illustrating a configuration of processing of changing control by the master-pressure control device of the brake control device illustrated in FIG. 1;

FIG. 4 is a flowchart for executing the changing control according to the embodiment of the present invention by the master-pressure control device of the brake control device illustrated in FIG. 1;

FIG. 5 is a flowchart for executing the changing control according to a first embodiment of the present invention by the master-pressure control device of the brake control device illustrated in FIG. 1;

FIG. 6 is a graph showing the relationship between a movement amount of the brake pedal and a pedaling force on the brake pedal by the changing control according to the first embodiment of the present invention;

FIG. 7 is a flowchart for executing the changing control according to a second embodiment of the present invention by the master-pressure control device of the brake control device illustrated in FIG. 1;

FIG. 8 is a graph showing the relationship between the movement amount of the brake pedal and the pedaling force on the brake pedal by the changing control according to the second embodiment of the present invention;

FIG. 9 is a flowchart for executing the changing control according to a third embodiment of the present invention by the master-pressure control device of the brake control device illustrated in FIG. 1;

FIG. 10 is a flowchart for executing the changing control according to a fourth embodiment of the present invention by the master-pressure control device of the brake control device illustrated in FIG. 1;

FIG. 11 is a graph showing the relationship between the movement amount of the brake pedal and the pedaling force on the brake pedal by the changing control according to the fourth embodiment of the present invention;

FIG. 12 is a flowchart for executing the changing control according to a fifth embodiment of the present invention by the master-pressure control device of the brake control device illustrated in FIG. 1;

FIG. 13 is a graph showing the relationship between the movement amount of the brake pedal and the pedaling force on the brake pedal by the changing control according to the fifth embodiment of the present invention; and

FIG. 14 is a graph showing the relationship between the movement amount of the brake pedal and a relative displacement amount between an input rod and a primary piston by the changing control according to the fifth embodiment of the present invention.

### DETAILED DESCRIPTION OF THE EMBODIMENTS

Hereinafter, embodiments of the present invention are described in detail referring to the accompanying drawings.

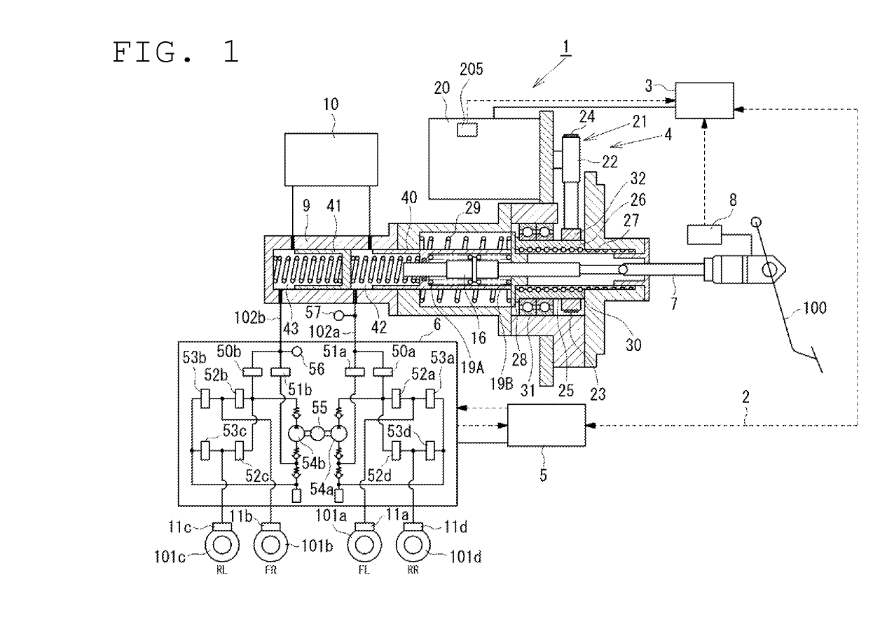

An overall configuration of a brake control device according to an embodiment of the present invention is illustrated in FIG. 1. In FIG. 1, arrowed broken lines indicate signal lines. The orientation of the arrow indicates the direction of a signal.

As illustrated in FIG. 1, a brake control device 1 according to this embodiment is applied to a braking device for an automobile so as to control a braking force on each of four wheels, that is, a front left wheel FL, a rear right wheel RR, a front right wheel FR, and a rear left wheel RL. The brake control device 1 includes a master cylinder 9, a reservoir tank 10, a master-pressure control mechanism 4, a master-pressure control device 3, a wheel-pressure control mechanism 6, and a wheel-pressure control device 5. The reservoir tank 10 is connected to the master cylinder 9. The master-pressure control mechanism 4 constitutes an electric booster for controlling a master pressure corresponding to a brake fluid pressure generated by the master cylinder 9. The master-pressure control device 3 is a controller for electrically controlling the master-pressure control mechanism 4. The wheel-pressure control mechanism 6 supplies the brake fluid pressure to hydraulic brake devices 11a to 11d of the wheels FL, RR, FR, and RL. The wheel-pressure control device 5 electrically controls the wheel-pressure control mechanism 6. In FIG. 1, the reference symbol FL denotes the front left wheel, FR denotes the front right wheel, RL denotes the rear left wheel, and RR denotes the rear right wheel.

Each of the hydraulic brake devices 11a to 11d includes a cylinder, a piston, and a brake pad (all not shown). The piston is thrust by the brake fluid pressure supplied from the wheel-pressure control mechanism 6. The brake pad connected to the piston is pressed against a corresponding one of disc rotors 101a and 101d to generate a frictional braking force. The disc rotors 101a to 101d rotate integrally with the wheels. A brake torque acting on each of the disc rotors 101a to 101d becomes a braking force acting between a corresponding one of the wheels and a road surface.

The master cylinder 9 is a tandem-type master cylinder which includes two pressurizing chambers, that is, a primary fluid-chamber 42 to be pressurized by a primary piston 40 and a secondary fluid-chamber 43 to be pressurized by a secondary piston 41. By the thrust of the primary piston 40, the secondary piston 41 is thrust. As a result, the brake fluid pressurized in the primary fluid-chamber 42 and the secondary fluid-chamber 43 passes through a primary pipe 102a and a secondary pipe 102b to be supplied to the hydraulic brake devices 11a to 11b for the respective wheels FL, RR, FR, and RL through the wheel-pressure control mechanism 6.

The reservoir tank 10 is connected to the primary fluid-chamber 42 and the secondary fluid-chamber 43 through reservoir ports. The reservoir ports are opened when the primary piston 40 and the secondary piston 41 are in backward positions to bring the primary fluid-chamber 42 and the secondary fluid-chamber 43 into communication with the reservoir tank 10 so as to appropriately replenish the primary fluid-chamber 42 and the secondary fluid-chamber 43 with the brake fluid. On the other hand, when the primary piston 40 and the secondary piston 41 move forward, the reservoir ports are closed to enable the pressurization of the primary fluid-chamber 42 and the secondary fluid-chamber 43.

As described above, the master cylinder 9 can supply the brake fluid to two-system hydraulic circuits through the primary pipe 102a and the secondary pipe 102b by the two pistons, that is, the primary piston 40 and the secondary piston 41. With this configuration, even if any one of the hydraulic circuits fails, the fluid pressure can be supplied by the other one of the hydraulic circuits. Therefore, the braking force can be ensured.

The master-pressure control mechanism 4 is configured so that an input piston 16 passes through a central portion of the primary piston 40 so as to be slidable and in a fluid-tight state, and a distal end of the input piston 16 is inserted into the primary fluid-chamber 42. An input rod 7 is connected to a rear end of the input piston 16. The input rod 7 is extended externally from the rear end of the master-pressure control mechanism 4. A brake pedal 100 is connected to a distal end of the extended part of the input rod 7. Together with the input rod 7, the input piston 16 constitutes an input member. A pair of centering springs 19A and 19B is provided between the primary piston 40 and the input piston 16. The primary piston 40 and the input piston 16 are elastically retained in neutral positions by spring forces of the centering springs 19A and 19B. The spring forces of the centering springs 19A and 19B act on a relative displacement between the primary piston 40 and the input piston 16 in an axial direction.

The master-pressure control mechanism 4 includes an electric motor 20, a ball-screw mechanism 25, and a belt speed-reduction mechanism 21. The electric motor 20 is an electric actuator for driving the primary piston 40 constituting a boosting member. The ball-screw mechanism 25 is a rotary-to-linear conversion mechanism and the belt speed-reduction mechanism 21 is a speed-reduction mechanism, which are provided between the primary piston 40 and the electric motor 20. The electric motor 20 includes a rotational-position sensor 205 for detecting a rotational position of the electric motor 20. The rotational-position sensor 205 is actuated in response to a command from the master-pressure control device 3 to obtain a desired rotational position. As the electric motor 20, for example, known DC motor, DC brushless motor, or AC motor can be used. In this embodiment, a three-phase DC brushless motor is used in view of controllability, quietness, and durability. Moreover, the amount of thrust of the ball-screw mechanism 25, that is, a displacement amount of the primary piston 40 can be calculated based on the signal from the rotational-position sensor 205.

The ball-screw mechanism 25 includes a screw shaft 27, a nut member 26, and a plurality of balls (steel balls) 30. The screw shaft 27 is a hollow linearly moving member into which the input rod 7 is inserted. The nut member 26 is a cylindrical rotational member into which the screw shaft 27 is inserted. The plurality of balls 30 are provided in screw grooves formed between the screw shaft 27 and the nut member 26. A front end of the nut member 26 comes into contact with a rear end of the primary piston 40 through an intermediation of a movable member 28. In this manner, the nut member 26 is rotatably supported by a bearing 31. The master-pressure control mechanism 4 rotates the nut member 26 by the electric motor 20 through an intermediation of the belt speed-reduction mechanism 21. In this manner, the balls 30 roll inside the screw grooves to linearly move the screw shaft 27 so as to press the primary piston 40 through an intermediation of the movable member 28. The screw shaft 27 is biased by a return spring 29 toward a backward position.

As the rotary-to-linear conversion mechanism, other mechanisms such as a rack-and-pinion mechanism may be used as long as the mechanism converts rotary movement of the electric motor 20 (that is, the belt speed-reduction mechanism 21) into linear movement so as to transmit the linear movement to the primary piston 40. In this embodiment, the ball-screw mechanism 25 is used in view of a small amount of play, efficiency, and durability. The ball-screw mechanism 25 has back-drivability and therefore, can rotate the nut member 26 by the linear movement of the screw shaft 27. The screw shaft 27 comes into contact with the primary piston 40 from behind so that the primary piston 40 can separate away from the screw shaft 27 to move forward alone. In this manner, even if the electric motor 20 cannot be actuated by wire disconnection or the like during the operation of the brake, that is, in a state in which the brake-fluid pressure is generated in the master cylinder 9, the screw shaft 27 is returned to the backward position by the spring force of the return spring 29. Therefore, the fluid pressure in the master cylinder 9 can be released so as to prevent brake dragging. When the electric motor 20 cannot be actuated, the primary piston 40 can separate away from the screw shaft 27 to move alone. Therefore, the input piston 16 can be moved forward by the brake pedal 100 through an intermediation of the input rod 7 and be then brought into contact with the primary piston 40 so as to directly operate the primary piston 40. In this manner, the fluid pressure can be generated to maintain the braking function.

The belt speed-reduction mechanism 21 includes a driving pulley 22, a driven pulley 32, and a belt 24. The driving pulley 22 is mounted to an output shaft of the electric motor 20. The driven pulley 32 is mounted to an outer circumferential portion of the nut member 26 of the ball-screw mechanism 25. The belt 24 is provided between and is looped around the driving pulley 22 and the driven pulley 32. The belt speed-reduction mechanism 21 decelerates the rotation of the output shaft of the electric motor 20 at a predetermined deceleration rate and then transmits the decelerated rotation to the ball-screw mechanism 25. The belt speed-reduction mechanism 21 may be combined with another speed-reduction mechanism such as a gear speed-reduction mechanism. In place of the belt speed-reduction mechanism 21, known gear speed-reduction mechanism, chain speed-reduction mechanism, differential speed-reduction mechanism, or the like can be used. If a sufficiently large torque is obtained by the electric motor 20, the speed-reduction mechanism may be omitted so that the ball-screw mechanism 25 is directly driven by the electric motor 20. In this manner, various problems relating to reliability, quietness, and mountability, which occur due to the intermediation of the speed-reduction mechanism, can be avoided.

A brake operation-amount detection device 8 is connected to the input rod 7. The brake operation-amount detection device 8 can detect at least the position or a displacement amount (stroke) of the input rod 7. The brake operation-amount detection device 8 may include a plurality of position sensors including a displacement sensor for the input rod 7, and a force sensor for detecting the pedaling force applied by a driver on the brake pedal 100. As a physical amount used for detecting the brake operation amount by the displacement sensor, the displacement amount of the input rod 7, the amount of stroke of the brake pedal 100, an angle of movement of the brake pedal 100, the pedaling force on the brake pedal 100, or the combination of a plurality of pieces of sensor information described above may be used. The brake operation-amount detection device 8 may have a configuration in which a plurality of pedaling-force sensors for detecting the pedaling force on the brake pedal 100 are combined or the displacement sensor and the pedaling-force sensor are combined. With the configuration described above, even if a signal from one of the sensors cannot be received, a braking request by the driver is detected and recognized by the remaining sensor(s). Therefore, fail-safe is ensured.

Electric-power supply and signal input processing are performed by the wheel-pressure control device 5 for at least one sensor of the sensors included in the brake operation-amount detection device 8, whereas electric-power supply and signal input processing are performed by the master-pressure control device 3 for the remaining sensor(s). In this manner, even if a CPU fault or a power fault occurs in any one of the master-pressure control device 3 and the wheel-pressure control device 5, the braking request by the driver is detected and recognized by the remaining sensor(s) and control device. Therefore, the fail-safe is ensured. Although only one brake operation-amount detection device 8 is illustrated in FIG. 1, brake operation-amount detection devices to be respectively connected to the master-pressure control device 3 and the wheel-pressure control device 5 may be provided.

Next, control performed by the master-pressure control device 3 on the master-pressure control mechanism 4 is described.

The electric motor 20 is actuated to control the position of the primary piston 40 so as to generate the fluid pressure based on an operation amount (the displacement amount, the pedaling force, or the like) of the brake pedal 100, which is detected by the brake operation-amount detection device 8. At this time, a reaction force generated by the fluid pressure acting on the input piston 16 is fed-back to the brake pedal 100 through the input rod 7. A boost ratio corresponding to a ratio of the operation amount of the brake pedal 100 and a generated fluid pressure can be adjusted by a pressure-receiving area ratio of the primary piston 40 and the input piston 16 and a relative displacement therebetween. At this time, a force in accordance with the master pressure acts on the brake pedal 100 through the input rod 7 so as to be transmitted to the driver as a brake-pedal reaction force. Therefore, a device for generating the brake-pedal reaction force is not additionally required. As a result, the brake control device 1 can be reduced in size as well as in weight to improve the mountability on a vehicle.

For example, the primary piston 40 is displaced so as to follow the displacement of the input piston 16 to perform relative-displacement control so that the relative displacement between the input piston 16 and the primary piston 40 becomes zero. In this manner, a constant boost ratio determined by the pressure-receiving area ratio of the input piston 16 and the primary piston 40 can be obtained. Moreover, the displacement of the input piston 16 may be multiplied by a proportional gain to change the relative displacement between the input piston 16 and the primary piston 40. In this manner, the boost ratio can be changed. Specifically, a movement amount of the primary piston 40 may be changed with respect to a movement amount of the input piston 16 to change the booster output with respect to the operation amount of the brake pedal 100.

In this manner, so-called brake-assist control can be executed. Specifically, the need of emergency braking is detected based on the operation amount of the brake pedal 100, an operating speed (a rate of change in the operation amount) of the brake pedal 100, and the like to increase the movement amount of the primary piston 40 to quickly obtain a needed braking force (fluid pressure). Further, regenerative cooperative control can also be executed. Specifically, the movement amount of the primary piston 40 is adjusted based on a signal from a regenerative braking system (not shown) so that the fluid pressure, which is reduced by the amount corresponding to regenerative braking, is generated at the time of regenerative braking, whereby a desired braking force is obtained by the sum of the braking force obtained by the regenerative braking and the braking force obtained by the fluid pressure. Further, automatic brake control can also be executed. Specifically, the electric motor 20 is actuated to move the primary piston 40 regardless of the operation of the brake pedal 100 (the displacement amount of the input piston 16 and the like) so that the braking force is generated. In this manner, the braking force is automatically adjusted based on a vehicle state detected by various sensor devices. The control is appropriately combined with other types of vehicle control such as engine control and steering control. As a result, vehicle-operation control such as vehicle-following control, lane departure avoidance control, and obstacle avoidance control can be executed by using the master-pressure control mechanism 4.

Next, the amplification of the thrust of the input rod 7 is described.

By displacing the primary piston 40 in accordance with the displacement amount of the input piston 16 through an intermediation of the input rod 7 by the braking operation performed by the driver, the thrust of the primary piston 40 is applied in accordance with the thrust of the input rod 7. Therefore, the primary fluid-chamber 42 is pressurized through amplification of the thrust of the input rod 7. An amplification ratio (hereinafter, referred to as “boost ratio”) can be arbitrarily set by the relative displacement between the input rod 7 and the primary piston 40, a ratio of a sectional area of the input piston 16 to that of the primary piston 40, and the like.

In particular, in the case where the primary piston 40 is displaced by the same amount as the displacement amount of the input rod 7 (in the case where the relative displacement between the input rod 7 and the primary piston 40 is set to 0), when a sectional area of the input piston 16 is “AI” and a sectional area of the primary piston 40 is “AA”, the boost ratio is uniquely determined by: (AI+AA)/AI. Specifically, by setting AI and AA based on a required boost ratio and then controlling the primary piston 40 so that the displacement amount of the primary piston 40 becomes equal to the displacement amount of the input piston 16, a given boost ratio can be constantly obtained. The displacement amount of the primary piston 40 can be calculated based on the output signal from the rotational-position sensor 205.

Next, processing for executing an output variable function is described. Output variable control processing is control processing for displacing the primary piston 40 by the amount obtained by multiplying the displacement amount of the input piston 16 by a proportional gain (K1). The proportional gain (K1) is desired to be 1 (K1=1) in view of controllability. However, when a large braking force exceeding the operation amount of the brake by the driver is required for emergency braking or the like, the proportional gain may be temporarily changed to a value exceeding 1 (K1>1). In this manner, even with the same brake operation amount, the master pressure can be increased as compared with that during a normal operation (when K1=1), thereby a larger braking force can be generated, while the spring forces of the centering springs 19A and 19B act with respect to the relative displacement between the input piston 16 and the primary piston 40 to adjust the reaction force acting on the input piston 16. The occurrence of emergency braking can be determined based on, for example, whether or not a temporal change rate of the signal from the brake operation-amount detection device 8 exceeds a predetermined value.

As described above, according to the output variable control processing, the master pressure is increased or reduced in accordance with the displacement amount of the input rod 7 in response to the braking request by the driver.

Therefore, the braking force as requested by the driver can be generated. Moreover, by setting the proportional gain (K1) to a value smaller than 1 (K1<1), the output variable control processing can be applied to the regenerative cooperative brake control for reducing the pressure of hydraulic braking by the amount of regenerative braking force in a so-called hybrid vehicle or electric automobile.

Next, processing for executing an automatic braking function is described.

The automatic-braking control processing is processing for moving the primary piston 40 forward and backward so as to adjust a working pressure of the master cylinder 9 to a requested fluid pressure for automatic braking (hereinafter, referred to as “automatic-braking request fluid pressure”). As a method of controlling the primary piston 40 in this case, there are a method involving extracting the displacement amount of the primary piston 40, for realizing the automatic-braking request fluid pressure, based on the relationship between the displacement amount of the primary piston 40 and the master pressure, which is previously obtained as a table, and setting the extracted displacement amount as a target value, a method involving feeding back the master pressure detected by master-pressure sensors 56 and 57, and the like. Any of the methods may be used. The automatic-braking request fluid pressure can be received from an external unit and can be used for, for example, the brake control in the vehicle-following control, the lane departure avoidance control, the obstacle avoidance control, and the like.

Next, a configuration and actuation of the wheel-pressure control mechanism 6 are described.

The wheel-pressure control mechanism 6 includes gate-OUT valves 50a and 50b, gate-IN valves 51a and 51b, IN valves 52a to 52d, OUT valves 53a to 53d, pumps 54a and 54b, an electric motor 55, and the master-pressure sensors 56 and 57. The gate-OUT valves 50a and 50b control the supply of the brake fluid pressurized by the master cylinder 9 to the respective hydraulic brake devices 11a to 11d. The gate-IN valves 51a and 51b control the supply of the brake fluid pressurized by the master cylinder 9 to the pumps 54a and 54b. The IN valves 52a to 52d control the supply of the brake fluid from the master cylinder 9 or the pumps 54a and 54b to the respective hydraulic brake devices 11a to 11d. The OUT valves 53a to 53d perform pressure-reduction control on the respective hydraulic brake devices 11a to 11d. The pumps 54a and 54b boost the brake fluid pressure generated by the master cylinder 9. The electric motor 55 drives the pumps 54a and 54b. The master-pressure sensors 56 and 57 detect the master pressure. As the wheel-pressure control mechanism 6, a fluid-pressure control unit for anti-lock brake control, a fluid-pressure control unit for vehicle-behavior stabilization control, or the like can be used.

The wheel-pressure control mechanism 6 includes two brake systems. Specifically, a first brake system is supplied with the brake fluid from the primary fluid-chamber 42 to control the braking forces of the wheels FL and RR. A second brake system is supplied with the brake fluid from the secondary fluid-chamber 43 to control the braking forces of the wheels FR and RL. With the use of the above-mentioned configuration, even when one of the brake systems fails, the braking forces for two diagonally-located wheels can be ensured by the other normal brake system. Thus, a vehicle behavior can be stably maintained.

The gate-OUT valves 50a and 50b are provided between the master cylinder 9 and the IN valves 52a to 52d, and are opened when the brake fluid pressurized by the master cylinder 9 is to be supplied to the hydraulic brake devices 11a to 11d. The gate-IN valves 51a and 51b are provided between the master cylinder 9 and the pumps 54a and 54b, respectively, and are opened when the brake fluid pressurized by the master cylinder 9 is to be boosted by the pumps 54a and 54b so as to be supplied to the hydraulic brake devices 11a to 11d.

The IN valves 52a to 52d are provided upstream of the hydraulic brake devices 11a to 11d, respectively, and are opened when the brake fluid pressurized by the master cylinder 9 or the pumps 54a and 54b is to be supplied to the hydraulic brake devices 11a to 11d. The OUT valves 53a to 53d are provided downstream of the hydraulic brake devices 11a to 11d, respectively, and are opened when the wheel pressure is to be reduced. The gate-OUT valves, the gate-IN valves, the IN valves, and the OUT valves are all electromagnetic valves which are opened and closed by the energization of a solenoid (not shown). Moreover, the amount of opening/closing of each of the valves can be independently adjusted by current control performed by the wheel-pressure control device 5.

The gate-OUT valves 50a and 50b and the IN valves 52a to 52d are normally-open valves, whereas the gate-IN valves 51a and 51b and the OUT valves 53a to 53d are normally-closed valves. With the above-mentioned configuration, even when the electric-power supply to the valves is stopped in case of a failure, the gate-IN valves 51a and 51b and the OUT valves 53a to 53d are closed and the gate-OUT valves 50a and 50b and the IN valves 52a to 52d are opened, and hence the brake fluid pressurized by the master cylinder 9 reaches all the hydraulic brake devices 11a to 11d. Therefore, the braking force as requested by the driver can be generated.

When a pressure higher than the working pressure of the master cylinder 9 is required for performing, for example, the vehicle-behavior stabilization control, the automatic-braking control, or the like, the pumps 54a and 54b boost the master pressure and then supply the boosted master pressure to the hydraulic brake devices 11a to 11d. As each of the pumps 54a and 54b, a plunger pump, a trochoid pump, a gear pump, or the like can be used. However, the gear pump is desirable in view of quietness.

The electric motor 55 is operated by the electric power supplied based on a control command from the wheel-pressure control device 5 to drive the pumps 54a and 54b connected to the electric motor 55. As the electric motor 55, a DC motor, a DC brushless motor, an AC motor, or the like can be used. However, the DC brushless motor is desirable in view of controllability, quietness, and durability.

The master-pressure sensor 56 is provided downstream of the secondary master pipe 102b, and the master-pressure sensor 57 is provided downstream of the primary master pipe 102a. Each of the master-pressure sensors 56 and 57 is a pressure sensor for detecting the master pressure. The number of the master-pressure sensors 56 and 57 and the locations where the master-pressure sensors 56 and 57 are provided can be arbitrarily determined in consideration of controllability, fail-safe, and the like.

The actuation of the above-mentioned wheel-pressure control mechanism 6 is controlled by the wheel-pressure control device 5 to control the brake fluid pressure to be supplied to the hydraulic brake devices 11a to 11d for the respective wheels FL, RR, FR, and RL. In this manner, various types of brake control are executed. For example, various types of brake control include, for example, braking-force distribution control for appropriately distributing the braking force to the respective wheels in accordance with a ground-contact load at the time of braking, anti-lock brake control for automatically adjusting the braking forces for the respective wheels at the time of braking so as to prevent the wheels from being locked, vehicle-stability control for suppressing understeering and oversteering to stabilize the vehicle behavior by detecting lateral sliding of the wheels in a running state to automatically apply the braking force to the respective wheels as appropriate, hill start aid (HSA) control for maintaining a braked state on a hill (uphill, in particular) to aid the start, traction control for preventing the wheels from spinning at the time of start or the like, vehicle-following control for keeping a constant distance from a leading vehicle, lane departure avoidance control for keeping running on a driving lane, and obstacle avoidance control for avoiding the collision with an obstacle.

In case of a failure of the master-pressure control device 3, the wheel-pressure control mechanism 6 (wheel-pressure control device 5) detects the brake operation amount performed by the driver based on the brake fluid pressure detected by the master-pressure sensor 56, and controls the pumps 54a and 54b so as to generate the wheel pressure in accordance with the detected value. In this manner, the braking function of the brake control device 1 can be exerted.

The master-pressure control device 3 and the wheel-pressure control device 5 perform bi-directional communication, and share a control command and vehicle state quantities (a yaw rate, a longitudinal acceleration, a lateral acceleration, a rudder angle of a steering wheel, a wheel speed, a vehicle-body speed, failure information, an operating state, and the like).

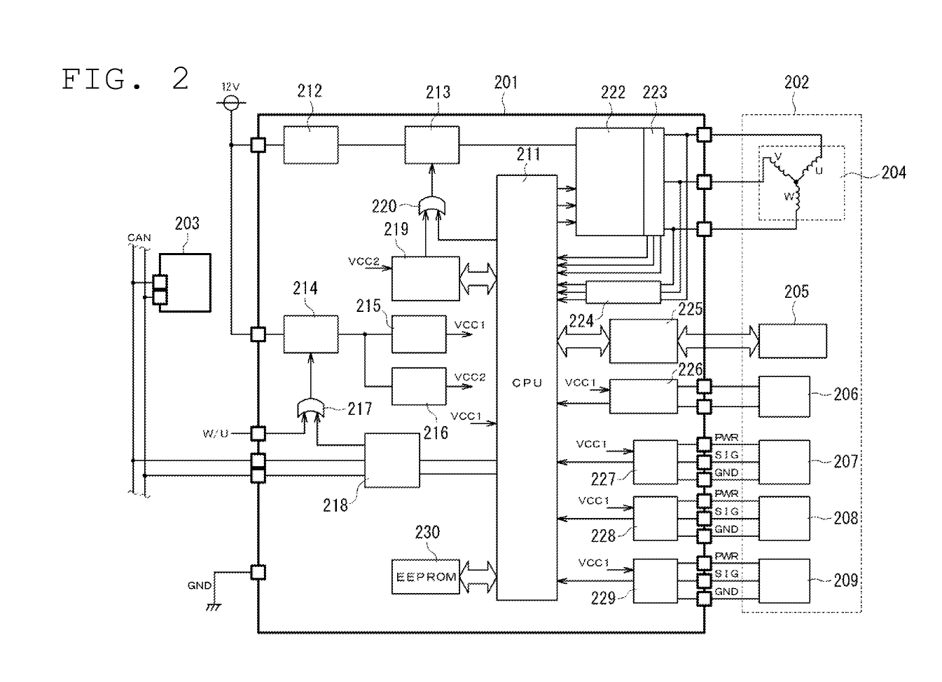

Next, referring to FIG. 2, an example of a circuit configuration of the master-pressure control device 3 is described.

In FIG. 2, an electric circuit of the master-pressure control device 3 is indicated by a heavy-line frame 201, whereas an electric circuit of the master-pressure control mechanism 4 is indicated by a dotted-line frame 202. A heavy-line frame 203 indicates an electric circuit of the wheel-pressure control device 5.

In the electric circuit 201 of the master-pressure control device 3, power supply supplied from a power-supply line provided in the vehicle through an ECU power-supply relay 214 is input to a 5V power-supply circuit (1) 215 and a 5V power-supply circuit (2) 216.

The ECU power-supply relay 214 is configured so as to be turned ON by any one of a seizing signal (W/U) and a seizing signal generated by the reception through a CAN in a CAN communication I/F 218. As the seizing signals, a door-switch signal, a brake-switch signal, an ignition-switch signal, or the like can be used. When a plurality of the above-mentioned switches are used, the circuit may be configured so that all the signals are fetched into the master-pressure control device 3 and the seizing signal actuates to turn the ECU power-supply relay 214 ON when any one of the switches for the plurality of signals is turned ON.

A stable power supply (VCC1) obtained by the 5V power-supply circuit (1) 215 is supplied to a central control circuit 211 (hereinafter, referred to as “CPU 211”). A stable power supply (VCC2) obtained by the 5V power-supply circuit (2) 214 is supplied to a monitoring control circuit 219.

A fail-safe relay circuit 213 can interrupt the electric-power supply to a three-phase motor driving circuit 222 described below from the power-supply line provided in the vehicle. The supply and the interruption of the power supply to the three-phase motor driving circuit 222 can be controlled by the CPU 211 and the monitoring control circuit 219.

After noise is removed through a filter circuit 212 from the power supply to be supplied through the fail-safe relay circuit 213, the power supply is supplied to the three-phase motor driving circuit 222 through the fail-safe relay circuit 213.

Vehicle information from the components other than the master-pressure control device 3, and the control signals such as the automatic-braking request fluid pressure are input to the CPU 211 through the CAN communication I/F circuit 218. The outputs from the rotational-angle sensor (rotational-position sensor) 205, a motor-temperature sensor 206, displacement sensors 207 and 208 (corresponding to the brake operation-amount detection device 8 illustrated in FIG. 1), and the master-pressure sensor 209 (corresponding to the master-pressure sensors 56 and 57 illustrated in FIG. 1), which are provided in the master-pressure mechanism 4, are input to the CPU 211 through a rotation-angle detection sensor I/F circuit 225, a motor-temperature sensor I/F circuit 226, displacement sensor I/F circuits 227 and 228, and a master-pressure sensor I/F circuit 229.

In the example illustrated in FIG. 2, the configuration includes the two displacement sensors 207 and 208 (corresponding to the brake operation-amount detection device 8 illustrated in FIG. 1). However, any configuration including at least one sensor may be used. The used sensor may be a pedaling-force sensor or a master-pressure sensor, or the configuration may include the combination of at least two different sensors.

In this manner, the information relating to the conditions of the master-pressure control mechanism 4 at the current time is input to control the master-pressure control mechanism 4 as well as to detect a fault state.

The CPU 211 outputs an appropriate signal to the three-phase motor driving circuit 222 based on the control signal from an external device and the detection values of the respective sensors to control the electric motor 20. In this case, a phase-current monitoring circuit 223 and a phase-voltage monitoring circuit 224 are provided for each phase of a three-phase output of the three-phase motor driving circuit 222. A phase current is monitored by the phase-current monitoring circuit 223, whereas a phase voltage is monitored by the phase-voltage monitoring circuit 224. The outputs of the phase-current monitoring circuits 223 and the phase-voltage monitoring circuits 224 appropriately operate the three-phase motor driving circuit 222 through the CPU 221. The three-phase motor driving circuit 222 is connected to a motor 204 (corresponding to the electric motor 20 illustrated in FIG. 1) included in the master-pressure control mechanism 4 so as to perform driving in accordance with the control performed by the CPU 211. Further, when each of the monitoring values deviates from a normal range or when the control is not performed as directed by the control command, the occurrence of a failure is determined.

The electric circuit 201 includes a storage circuit 230 formed of an EEPROM which stores, for example, failure information. The signal is transmitted and received between the storage circuit 230 and the CPU 211. The CPU 211 can store the detected failure information and learning values used for the control of the master-pressure control mechanism 4 (for example, a control gain, offset values of various sensors, and the like) in the storage circuit 230. The electric circuit 201 also includes a monitoring control circuit 219 with which the CPU 211 performs the transmission and reception of the signal. The monitoring control circuit 219 monitors a failure of the CPU 211, the VCC1 voltage, and the like. When an abnormality of the CPU 211 or the VCC1 voltage is detected, the fail-safe relay 213 is quickly operated to interrupt the electric-power supply to the three-phase motor driving circuit 222. The monitoring control circuit 219 and the VCC2 voltage are monitored by the CPU 211.

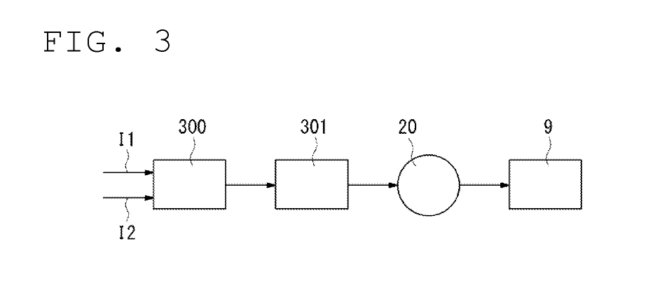

Next, changing control for the master-pressure control mechanism 4, which is performed by the master-pressure control device 3, is described referring to FIGS. 3 to 14.

Processing for executing the changing control for the master-pressure control mechanism 4, which is performed by the master-pressure control device 3, is illustrated in FIG. 3. As illustrated in FIG. 3, the master-pressure control device 3 includes control changing unit 300 and motor-driving unit 301. The control changing unit 300 determines a target movement amount of the primary piston 40 based on a control input I1 and a control changing input I2. The motor driving unit 301 supplies a driving current to the electric motor 20 based on an output signal of the control changing unit 300.

In this embodiment, as the control input I1 input to the control changing unit 300, the displacement amount (movement amount) of the input rod 7 connected to the brake pedal 100 is used. Besides the displacement amount of the input rod 7, the pedaling force applied by the driver on the brake pedal 100, or an estimated pedaling-force obtained by a calculation by estimation unit (not shown) from the position of the input rod 7, the position of the primary piston 40, the fluid pressure in the master cylinder 9, the spring forces of the centering springs 19A and 19B, and the like can also be used. In this case, any of the displacement amount of the input rod 7, the pedaling force, and the estimated pedaling-force may be used as the control input I1 or a plurality thereof may be combined as the control input I1. The control input I1 is used to obtain the target displacement amount (movement amount) of the primary piston 40. The displacement amount of the primary piston 40 may be obtained from a table on which the relationship between the displacement amount of the primary piston 40 and the control input I1 is preset or may be obtained by a predetermined computation based on the control input I1.

The control changing unit 300 changes a ratio of the movement amount of the primary piston 40 to the movement amount of the input rod 7 based on the control changing input I2. As the control changing input I2, the position of the input rod 7, the position of the primary piston 40, the fluid pressure in the master cylinder 9, the current flowing through the electric motor 20, or the above-mentioned estimated pedaling-force can be used. In this case, any one of the values described above may be used as the control changing input I2 or a plurality of the values may be combined as the control changing input I2.

The motor driving unit 301 supplies the driving current to the electric motor 20 based on the target movement amount (target position) of the primary piston 40, which is determined by the control changing unit 300, to drive the electric motor 20 so that the movement amount of the primary piston 40 becomes equal to the target movement amount. In this manner, the electric motor 20 moves the primary piston 40 by the target movement amount so that a desired brake fluid pressure is generated by the master cylinder 9.

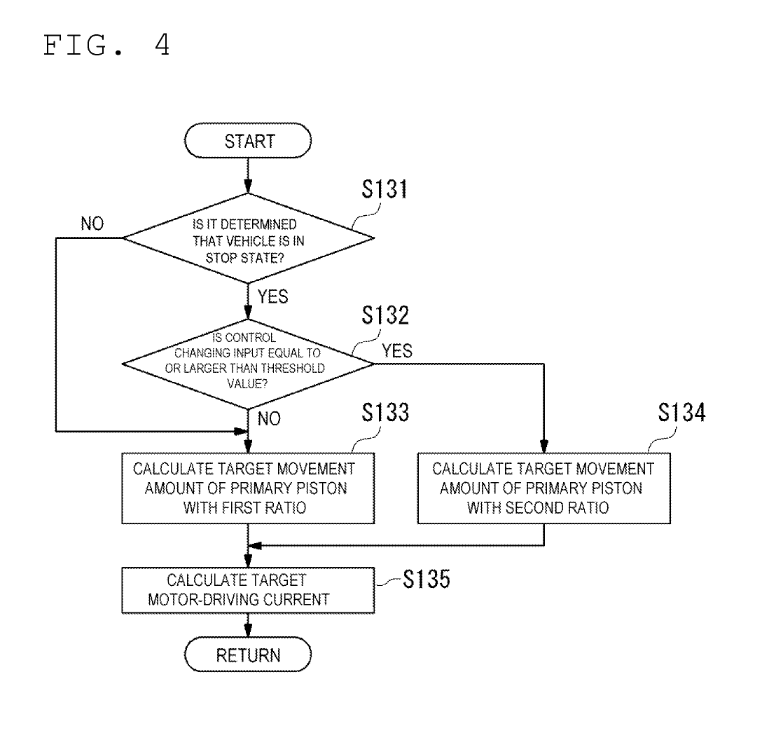

In this embodiment, the ratio of the movement amount of the primary piston 40 with respect to the control input I1 is reduced during the movement of the brake pedal 100 based on the control input I1 and the control changing input I2. In this manner, a shift of the position of full-load point, at which the output of the electric motor 20 during an operation stroke of the brake pedal 100 becomes maximum, and the elimination or reduction of the operation stroke from the full-load point to an abutment point at which the input piston 16 comes into contact with the primary piston 40, are to be realized. With the configuration described above, a fluctuation in the pedaling force on the brake pedal 100 can be reduced to improve a brake-pedal feeling of the brake pedal 100. Hereinafter, specific processing for changing the ratio of the movement amount of the primary piston 40 with respect to the control input I1 by the control changing unit 300 is described referring to FIG. 4.

First, in Step S131, it is determined whether or not the vehicle is in a stop state. In this step, whether or not the vehicle is in a stop state can be determined, for example, based on the vehicle-speed information fetched from the vehicle-speed sensor (not shown), by fetching vehicle-stop information fetched by another unit of the vehicle through the CAN communication I/F circuit 218 by the CAN communication, or by fetching the result of determination that the vehicle is in a stop state, which is made by another unit of the vehicle, via the CAN communication.

When it is determined that the vehicle is in a stop state, whether or not the control changing input I2 is equal to or larger than a predetermined threshold value for performing changing between a first ratio and a second ratio is determined in Step S132. In this step, any one of the movement amount of the input rod 7 described below (first embodiment), the fluid pressure in the master cylinder 9 (second embodiment), the pedaling force on the brake pedal 100 (including the estimated pedaling-force calculated by using the information fetched into the master-pressure control device 3) (third embodiment), the current value of the current to energize the electric motor 20 (fourth embodiment), and the amount of relative displacement between the input rod 7 and the primary piston 40 (fifth embodiment), or the combination of a plurality of the pieces of information described above can be used as the control changing input I2.

When the control changing input I2 is smaller than the threshold value, the target position of the primary piston 40 is determined so that the ratio of the movement amount of the primary piston 40 to the movement amount of the input rod 7, which serves as the control input I1, becomes equal to a predetermined first ratio in Step S133. On the other hand, when the control changing input I2 is equal to or larger than the threshold value, the target position of the primary piston 40 is determined so the ratio of the movement amount of the primary piston 40 to the movement amount of the input rod 7 becomes equal to a second ratio which is smaller than the first ratio in Step S134. Then, in Step S135, the driving current is supplied to the electric motor 20 by the motor driving unit 301 so that the primary piston 40 moves to the target position. When it is not determined in Step S131 that the vehicle is in a stop state, the target position of the primary piston 40 is determined so that the ratio of the movement amount of the primary piston 40 to the movement amount of the input rod 7 becomes equal to the first ratio in Step S133.

As described above, in this embodiment, changing control for changing the ratio of the movement amount of the primary piston 40 with respect to the control input I1 from the first ratio to the second ratio smaller than the first ratio is executed. By performing the control described above, a fluctuation in the pedaling force on the brake pedal 100, at the full-load point at which the output of the electric motor 20 becomes maximum, and at the abutment point at which the input piston 16 comes into contact with the primary piston 40, can be reduced. Therefore, the brake-pedal feeling of the brake pedal 100 can be improved.

Next, conditions for determining that the vehicle is in a stop state in Step S131 are described. In general, besides sudden braking, there are not many situations under which the brake pedal 100 is depressed to exceed the full-load point while the vehicle is running. On the other hand, while the vehicle is in a stop state or immediately before the vehicle is stopped, the vehicle is not decelerated at a large deceleration rate. Therefore, the driver can firmly depress the brake pedal 100 and is likely to feel a change in the brake-pedal feeling of the brake pedal 100. Therefore, in the case where the control is desired to be performed without lowering the boost ratio immediately before the vehicle is stopped, it should be determined that the vehicle is in a stop state when the vehicle speed is zero or when a state in which the vehicle speed is zero lasts for a predetermined period of time. Moreover, in the case where the brake-pedal feeling immediately before the stop of the vehicle is desired to be improved, it should be determined that the vehicle is in a stop state when the vehicle speed is equal to or smaller than a given speed. In this manner, the brake-pedal feeling of the brake pedal 100 can be improved while the boost ratio is increased to some extent when the vehicle is running and while the fluctuation in pedaling force on the brake pedal 100 is reduced when the vehicle is in a stop state or immediately before the vehicle is stopped.

Specific examples of the determination of whether or not the control changing input I2 is equal to or larger than the predetermined threshold value for performing changing between the first and second ratios in Step S132 described above are described below as first to fifth embodiments. In the embodiment described above, whether or not the vehicle is in a stop state is determined in Step S131. However, whether or not the vehicle is in a stop state is not necessarily required to be determined. In the following first to fifth embodiments described below, the control is performed regardless of whether or not the vehicle is in a stop state.

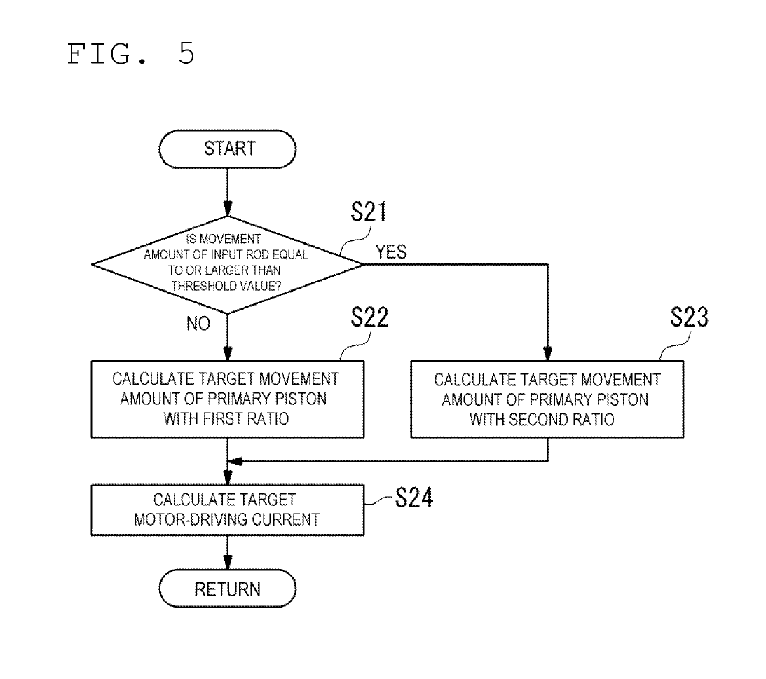

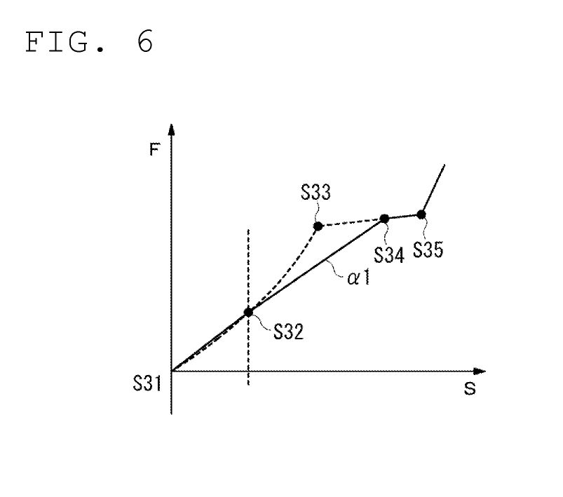

As the first embodiment, processing for executing the changing control for changing the ratio of the movement amount of the primary piston 40 to the movement amount of the input rod 7 in accordance with whether or not the movement amount (stroke) of the input rod 7, which is used as the control changing input I2, is equal to or larger than the threshold value is described referring to FIGS. 5 and 6.

Referring to FIG. 5, in Step S21, it is determined whether or not the movement amount of the input rod 7 is equal to or larger than the threshold value. When the movement amount of the input rod 7 is smaller than the predetermined threshold value, the target position (movement amount) of the primary piston 40 is determined so that the ratio of the movement amount of the primary piston 40 to the movement amount of the input rod 7 becomes equal to the predetermined first ratio in Step S22. On the other hand, when the movement amount of the input rod 7 is equal to or larger than the threshold value, the target position of the primary piston 40 is determined so that the ratio of the movement amount of the primary piston 40 to the movement amount of the input rod 7 becomes equal to the second ratio which is smaller than the first ratio in Step S23. Then, in Step S24, the driving current is supplied to the electric motor 20 by the motor driving unit 301 so that the primary piston 40 moves to the target position. Alternatively, in Step S21, it may determined whether or not the movement amount of the primary piston (boosting member) 40 is equal to or larger than the threshold value, and the changing control may be executed when the movement amount of the primary piston 40 reaches the threshold value. Meanwhile, the first ratio and the second ratio may be a ratio for an advance control (K1>1), a delay control (K1<1), or a relative displacement zero control (K1=1), as long as the second ratio is smaller than the first ratio.

FIG. 6 shows the relationship between the movement amount (stroke; indicated by S in FIG. 6) of the brake pedal 100 and the pedaling force (indicated by F in FIG. 6) on the brake pedal 100 when the control illustrated in FIG. 5 is applied. Referring to FIG. 6, when the driver depresses the brake pedal 100 in a state in which the brake pedal 100 is located at a non-braking position S31 (stroke 0) at which the brake pedal 100 is released, the primary piston 40 moves so that the ratio of the movement amount of the primary piston 40 to the movement amount of the input rod 7 becomes equal to the first ratio. At this time, the pedaling force on the brake pedal 100 is increased by a reaction force acting on the brake pedal 100, which is generated by an increase in fluid pressure in the master cylinder 9, in addition to the spring forces of the centering springs 19A and 19B.

Then, when the movement amount of the input rod 7 reaches a changing point S32 corresponding to a predetermined threshold value, the ratio of the movement amount of the primary piston 40 to the movement amount of the input rod 7 is changed or switched from the first ratio to the second ratio which is smaller than the first ratio. At this time, the changing point S32, at which the control is changed or switched, is set so as to be smaller than a first full-load point S33 at which the movement amount of the primary piston 40 by the electric motor 20 becomes maximum (the output of the electric motor 20 becomes maximum) in the control with the first ratio.

At the changing point S32, the execution of the control with the second ratio is started. Then, the movement amount of the input rod 7 reaches a second full-load point S34 at which the movement amount of the primary piston 40 by the electric motor 20 becomes maximum in the control with the second ratio (the output of the electric motor 20 becomes maximum). After the movement amount of the primary piston 40 reaches the second full-load point S34, the primary piston 40 is stopped and only the input rod 7 moves forward by the pedaling force applied by the driver on the brake pedal 100. At this time, a ratio of the increase in reaction force to the stroke of the brake pedal 100 is reduced. Then, when the input rod 7 moves to the abutment point S35, the input piston 16 comes into contact with the primary piston 40. After the movement amount of the input rod 7 reaches the abutment point S35, the primary piston 40 is thrust together with the input rod 7 and the input piston 16 by the pedaling force applied by the driver on the brake pedal 100. Therefore, the ratio of the increase in pedaling force to the stroke of the brake pedal 100 is increased. The abutment point S35 depends on size of each section of the master-pressure control mechanism 4, downstream stiffness of the hydraulic circuits of the master cylinder 9, the maximum output of the electric motor 20, and the like. By setting the second full-load point S34 and the abutment point S35 to the same point, a period from the second full-load point S34 to the abutment point S35, in which the pedaling force has a small gradient, is eliminated. Therefore, the fluctuation in pedaling force with respect to the movement amount of the brake pedal 100 is reduced to improve the brake-pedal feeling of the brake pedal 100. The downstream stiffness of the hydraulic circuits of the master cylinder 9 indicates a required fluid amount and a required fluid pressure of the hydraulic brake devices 11a to 11d. The required fluid amount and the required fluid pressure of the hydraulic brake devices 11a to 11d for a target deceleration rate change depending on the conditions of use. Specifically, a hardness of a friction pad provided to each of the hydraulic brake devices 11a to 11d changes depending on a temperature or the degree of wear. For example, when the temperature of the friction pad increases to soften the friction pad, the downstream stiffness tends to become lower. On the other hand, when the wear of the friction pad progresses to harden the friction pad, the downstream stiffness tends to become higher.

As described above, by executing the changing control for changing the ratio of the movement amount of the primary piston 40 to the movement amount of the input rod 7 from the first ratio to the second ratio which is smaller than the first ratio, the fluctuation in pedaling force on the brake pedal 100 at the full-load point, at which the output of the electric motor 20 becomes maximum, and the abutment point, at which the input piston 16 comes into contact with the primary piston 40, is reduced to improve the brake-pedal feeling of the brake pedal 100.

Next, specific examples of a method of setting the changing point S32 and the second full-load point S34 are described as first to third setting methods. The setting method is not limited to the first to third setting methods described below. Other setting methods can be used as the setting method. According to the first setting method, the changing point S32 and the second full-load point S34 are set based on a gradient al of a line segment between the changing point S32 and the second full-load point S34. The changing point S32 is set so as to be smaller than the first full-load point S33 as described above. However, in a region with a small pedaling force on the brake pedal 100 where the frequency of use of the brake pedal 100 is high, the changing point S32 should be determined so that the control with the first ratio, which increases the boost ratio, can be performed. In this manner, on the side on which the pedaling force is small, the brake-pedal feeling of the brake pedal 100 when the brake pedal 100 is further depressed can be improved while a sufficient boost ratio is maintained. Moreover, when the gradient α1 is set smaller (when the second ratio is set smaller), a change in the pedaling force on the brake pedal 100 at the changing point S32 becomes abrupt. Therefore, the gradient α1 is determined so as to smooth the change in pedaling force with respect to the movement amount of the brake pedal 100 from the non-braking position S31 to the second full-load point S34.

According to the second setting method, the changing point S32 and the second full-load point S34 are set based on the position of the second full-load point S34 and the gradient α1 of the line segment between the changing point S32 and the second full-load point S34. When the second full-load point S34 is higher than the abutment point S35, the input piston 16 comes into contact with the primary piston 40 before the output of the electric motor 20 becomes maximum. As a result, a sufficient boost ratio cannot be obtained with respect to the output of the electric motor 20 and therefore, efficiency is low. Thus, it is desirable that the second full-load point S34 be at the same position as or smaller than the abutment point S35. The abutment point S35 changes depending on the downstream stiffness of the hydraulic circuits of the master cylinder 9. Therefore, the second full-load point S34 is necessarily set so as to be smaller than the abutment point S35 in consideration of the downstream stiffness. Although the second full-load point S34 can be determined based on the input signal of the master-pressure control device 3, the second full-load point S34 should be set so as to be smaller than the abutment point S35 without fail in consideration of a maximum error of the input signal. By setting the gradient al smaller (by setting the second ratio smaller), the change in pedaling force on the brake pedal 100 at the changing point S32 becomes abrupt. Therefore, the gradient α1 should be determined so that the change in pedaling force with respect to the movement amount of the brake pedal 100 from the non-braking position S31 to the second full-load point S34 becomes smooth. A point of intersection of the line segment passing through the second full-load point S34, which has the gradient α1, and a line segment from the non-braking position S31 to the first full-load point S33 becomes the changing point S32. With the first setting method described above, the abutment point S35 is separated away from the second full-load point S34 in some cases. Therefore, when the change in gradient of the line segment from the non-braking position S31 to the abutment point S35 is desired to be smoother, the second setting method should be used.

According to the third setting method, the changing point S32 and the second full-load point S34 are set. Even in this case, the second full-load point S34 is set so as to be smaller than the abutment point S35 without fail. In this manner, a necessary braking force can be obtained over the entire region where the pedaling force is low while the sufficient boost ratio is maintained.

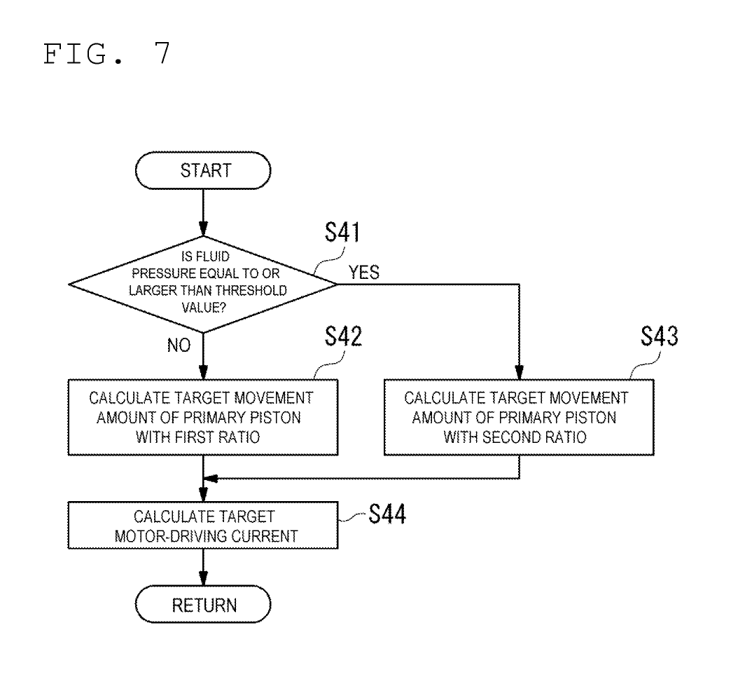

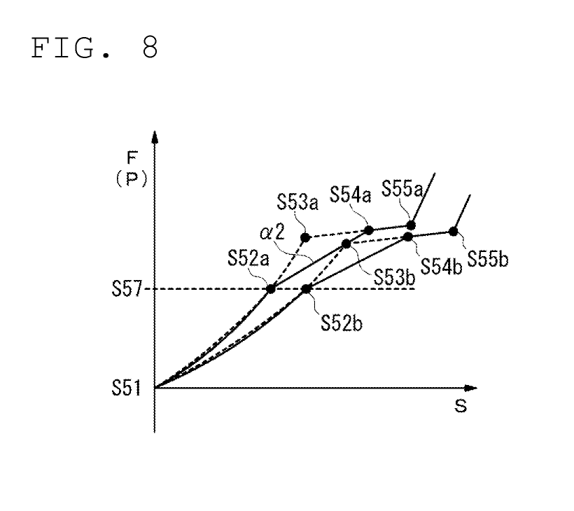

Next, as the second embodiment, processing for changing the ratio of the movement amount of the primary piston 40 to the movement amount of the input rod 7 in accordance with whether or not the brake fluid pressure in the master cylinder 9, which is used as the control changing input I2, is equal to or larger than the threshold value, is described referring to FIGS. 7 and 8.

Referring to FIG. 7, in Step S41, it is determined whether or not the brake fluid pressure in the master cylinder 9 is equal to or larger than the threshold value. When the brake fluid pressure in the master cylinder 9 is smaller than the threshold value, the target position of the primary piston 40 is determined so that the ratio of the movement amount of the primary piston 40 to the movement amount of the input rod 7 becomes equal to the first ratio in Step S42. On the other hand, when the brake fluid pressure in the master cylinder 9 is equal to or larger than the threshold value, the target position of the primary piston 40 is determined so that the ratio of the movement amount of the primary piston 40 to the movement amount of the input rod 7 becomes equal to the second ratio which is smaller than the first ratio in Step S43. Then, in Step S44, the driving current is supplied to the electric motor 20 by the motor driving unit 301 so that the primary piston 40 moves to the target position.

FIG. 8 shows the relationship between the movement amount (stroke; indicated by S in FIG. 8) of the brake pedal 100, and each of the pedaling force (indicated by F in FIG. 8) on the brake pedal 100 and the brake fluid pressure (indicated by P in FIG. 8) in the master cylinder 9, when the changing control illustrated in FIG. 7 is applied. The brake fluid pressure in the master cylinder 9 is approximately proportional to the pedaling force applied by the driver on the brake pedal 100. Therefore, the relationship between the movement amount of the brake pedal 100 and the brake fluid pressure is approximately the same as the relationship between the movement amount of the brake pedal 100 and the pedaling force applied by the driver on the brake pedal 100. In FIG. 8, a curve from S52a to S55a indicates a transition when the downstream stiffness of the hydraulic circuits of the master cylinder 9 is higher than that with a curve from S52b to S55b.

The brake pedal 100 is depressed when being located at the non-braking position S51 (stroke 0). Then, the primary piston 40 moves so that the ratio of the movement amount of the primary piston 40 to the movement amount of the input rod 7 becomes equal to the first ratio. Then, when the fluid pressure in the master cylinder 9 reaches a threshold value S57 (at the changing points S52a and S52b), the control is changed or switched so that the ratio of the movement amount of the primary piston 40 to the movement amount of the input rod 7 is changed or switched from the first ratio to the second ratio. The threshold value S57 of the fluid pressure in the master cylinder 9, at which the control is changed or switched, is set so as to be smaller than the full load points S53a and S53b, at which the movement amount of the primary piston 40 by the electric motor 20 becomes maximum (the output of the electric motor 20 becomes maximum) in the control with the first ratio. In this manner, the amount of change in gradient of the pedaling force with respect to the movement amount of the brake pedal 100, before and after the passage of the brake fluid pressure in the master cylinder 9 through the threshold value S57, becomes smaller than the amount of change in gradient of the pedaling force with respect to the movement amount of the brake pedal 100, before and after the passage of the brake fluid pressure through the full-load point S53a or S53b in the case where the control is not changed or switched (see broken lines shown in FIG. 8). Therefore, a feeling of discomfort given by a sudden reduction in pedaling force on the brake pedal 100 at the full-load point S53a or S53b can be reduced.

After the control is changed or switched so as to change or switch the first ratio to the second ratio at the changing points S52a and S52b, the control with the second ratio is executed. In the control with the second ratio, the movement amount of the brake pedal 100 reaches the second full-load point S54a or S54b at which the movement amount of the primary piston 40 by the electric motor 20 becomes maximum (the output of the electric motor 20 becomes maximum). After the movement amount of the brake pedal 100 reaches the second full-load points S54a and S54b, the primary piston 40 is stopped and only the input rod 7 moves forward by the pedaling force applied by the driver on the brake pedal 100. Then, when the input rod 7 moves to the abutment points S55a and S55b, the input piston 16 comes into contact with the primary position 40. Thereafter, the primary piston 40 is thrust together with the input rod 7 and the input piston 16 by the pedaling force applied by the driver on the brake pedal 100. As a result, the degree of increase in pedaling force with respect to the stroke of the brake pedal 100 is increased.

At this time, a fluctuation in pedaling force with respect to the stroke of the brake pedal 100 is reduced when the pedaling force with respect to the stroke of the brake pedal 100 reaches the abutment points S55a and S55b through the changing points S52a and S52b and the second full-load points S54a and S54b as compared with the case where the pedaling force reaches the abutment points S55a and S55b through the first full-load points S53a and S53b. Therefore, the brake-pedal feeling of the brake pedal 100 can be improved.

By determining the changing points S52a and S52b for changing the first ratio to the second ratio based on the threshold value S57 of the brake fluid pressure, the control with the first ratio, which provides a large boost ratio, is executed until the brake fluid pressure reaches the threshold value S57 even when the downstream stiffness of the hydraulic circuits of the master cylinder 9 changes. Therefore, in the region with the low pedaling force where the frequency of use of the brake pedal 100 is high, a sufficiently large boost ratio can be obtained. On the other hand, in a region with a high pedaling force, the brake-pedal feeling when the brake pedal 100 is depressed can be improved.

Next, specific examples of a method of setting the second full-load points S54a and S54b are described as first and second setting methods. The setting method is not limited to the first and second setting methods described below, and other setting methods can also be used. Although the application of the setting method to the curve from S52a to S55a is described below, the same method can also be applied to the curve from S52b to S55b. According to the first setting method, a gradient α2 of a curve from the changing point S52a to the second full-load point S54a is first determined. Then, the second full-load point S54a is determined. When the gradient α2 is set small, a change in pedaling force on the brake pedal 100 at the changing point S52a becomes abrupt. Therefore, the gradient α2 is determined so that a gradient from the non-braking position S51 to the second full-load point S54a becomes smooth.

According to the second setting method, the second full-load point S54a is set based on the movement amount (stroke) of the input rod 7. In this case, a difference between the fluid pressure at the second full-load point S54a and the fluid pressure at the abutment point S55a at which the input piston 16 comes into contact with the primary piston 40 should be set small. The second full-load point S54a may be set based on the fluid pressure in the master cylinder 9. However, when any of the detection values of the master-pressure sensors 56 and 57 has an error, the position of the second full-load point S54a is shifted. Therefore, the second full-load point S54a may be set based on the movement amount of the input rod 7, with which the error is hardly generated. Moreover, the abutment point S55a changes depending on the downstream stiffness of the hydraulic circuits of the master cylinder 9. Therefore, the second full-load point S54a is set so as to be smaller than the abutment point S55a without fail.

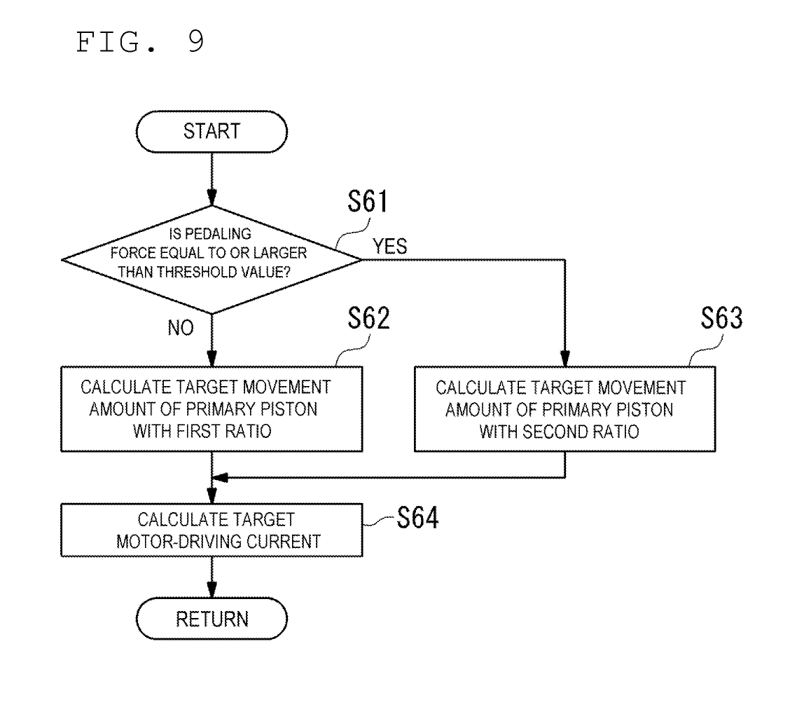

Next, as a third embodiment, processing for changing the ratio of the movement amount of the primary piston 40 to the movement amount of the input rod 7 in accordance with whether or not the pedaling force applied by the driver on the brake pedal 100, which is used as the control changing input I2, is equal to or larger than a predetermined threshold value, is described referring to FIG. 9.

Referring to FIG. 9, in Step S61, it is determined whether or not the pedaling force applied by the driver on the brake pedal 100 is equal to or larger than the threshold value. When the pedaling force is smaller than the threshold value, the target position of the primary piston 40 is determined so that the ratio of the movement amount of the primary piston 40 to the movement amount of the input rod 7 becomes equal to the first ratio in Step S62. On the other hand, when the pedaling force is equal to or larger than the threshold value, the target position of the primary piston 40 is determined so that the ratio of the movement amount of the primary piston 40 to the movement amount of the input rod 7 becomes equal to the second ratio which is smaller than the first ratio in Step S63. At this time, the pedaling force used for the determination may be acquired by using the pedaling-force sensor mounted to the brake pedal 100. Alternatively, an estimated pedaling-force obtained by a calculation with estimation unit (not shown) from the position of the input rod 7, the position of the primary piston 40, the fluid pressure in the master cylinder 9, the spring forces of the centering springs 19A and 19B, and the like may be used. Then, in Step S64, the driving current is supplied to the electric motor 20 by the motor driving unit 301 so that the primary piston 40 moves to the target position.

The relationship between the movement amount (stroke) of the brake pedal 100 and the pedaling force when the control illustrated in FIG. 9 is applied becomes the same as the relationship illustrated in FIG. 8 in which the threshold value S57 of the brake fluid pressure is replaced by the threshold value of the pedaling force.

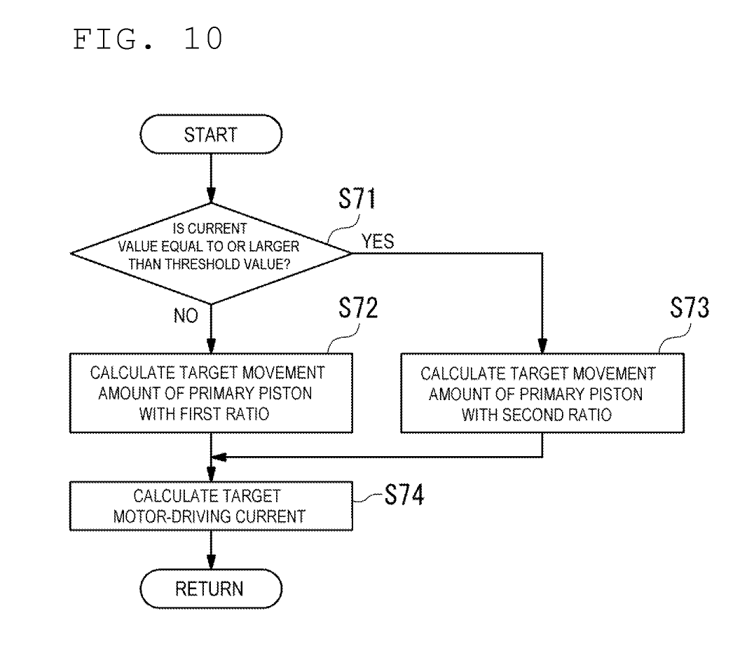

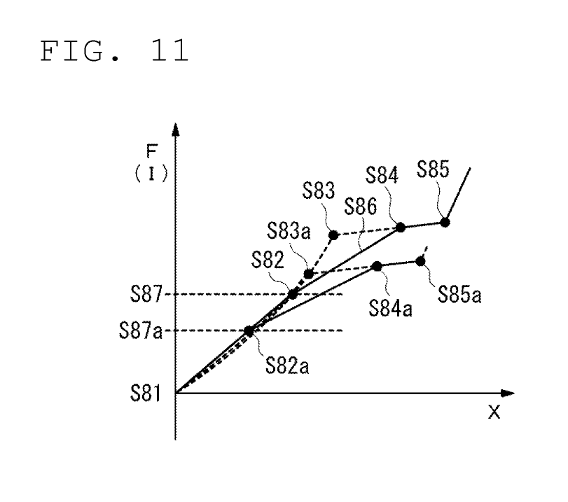

Next, as the fourth embodiment, processing for changing the ratio of the movement amount of the primary piston 40 to the movement amount of the input rod 7 in accordance with whether or not the current value of the current flowing through the electric motor 20, which is used as the control changing input I2, is equal to or larger than a predetermined threshold value is described referring to FIGS. 10 and 11.

Referring to FIG. 10, in Step S71, it is determined whether or not the current value of the current flowing through the electric motor 20 is equal to or larger than the threshold value. When the current value is smaller than the threshold value, the target position of the primary piston 40 is determined so that the ratio of the movement amount of the primary piston 40 to the movement amount of the input rod 7 becomes equal to the first ratio in Step S72. On the other hand, when the current value is equal to or larger than the threshold value, the target position of the primary piston 40 is determined so that the ratio of the movement amount of the primary piston 40 to the movement amount of the input rod 7 becomes equal to the second ratio which is smaller than the first ratio in Step S73. Then, in Step S64, the driving current is supplied to the electric motor 20 by the motor driving unit 301 so that the primary piston 40 moves to the target position.

FIG. 11 shows the relationship between the movement amount (stroke; indicated by S in FIG. 11) of the brake pedal 100 and the pedaling force on the brake pedal 100 when the control illustrated in FIG. 10 is applied. In this case, the current value (indicated by I in FIG. 11) of the current flowing through the electric motor 20, the torque of the electric motor 20, the brake fluid pressure in the master cylinder 9, and the pedaling force (indicated by F in FIG. 11) on the brake pedal 100 have an approximately proportional relationship. Therefore, a characteristic indicated by a curve from S81 to S85 is approximately the same as that illustrated in FIG. 8. A threshold value S87 of the current, at which the first ratio is to be changed or switched to the second ratio, is set so as to be smaller than the current value at a first full-load point S83 at which the movement amount of the primary piston 40 by the electric motor 20 becomes maximum (the output of the electric motor 20 becomes maximum) in the control with the first ratio.

In this manner, the amount of change in gradient of the pedaling force with respect to the movement amount of the brake pedal 100, before and after the current value of the current flowing through the electric motor 20 passes through the threshold value S87 and the second full-load point S84, becomes smaller than the amount of change in gradient of the pedaling force, before and after the current value of the current passes through the full-load point S83 in the control with the first ratio(see a broken line shown in FIG. 8). Therefore, a feeling of discomfort provided to the driver, due to a sudden reduction in pedaling force on the brake pedal 100 at the full-load point, can be reduced.

Next, the case where the maximum current flowing to energize the electric motor 20 is limited to prevent overheat of a coil of the electric motor 20 is described referring to the curve from S81 to S85a. In this case, by changing the threshold value of the current, at which the ratio of the movement amount of the primary piston 40 to the movement amount of the input rod 7 is changed from the first ratio to the second ratio, to a threshold value S87a smaller than the threshold value S87, the change in gradient of the pedaling force on the brake pedal 100 in a period from S81 through S82a to S85a is reduced. As a result, a feeling of discomfort provided to the driver can be reduced.

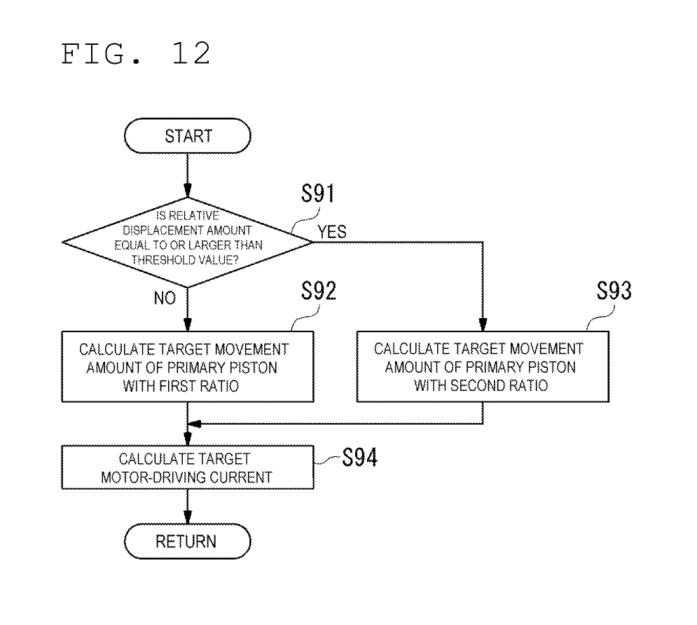

Next, as the fifth embodiment, processing for changing the ratio of the movement amount of the primary piston 40 to the movement amount of the input rod 7 in accordance with whether or not the relative displacement amount between the input rod 7 and the primary piston 40, which is used as the control changing input I2, is equal to or larger than a predetermined threshold value, is described referring to FIGS. 12 to 14.

Referring to FIG. 12, in Step S91, it is determined whether or not the relative displacement amount between the input rod 7 and the primary piston 40 is equal to or larger than the threshold value. When the relative displacement amount is smaller than the threshold value, the target position of the primary piston 40 is determined so that the ratio of the movement amount of the primary piston 40 to the movement amount of the input rod 7 becomes equal to the first ratio for increasing the relative displacement amount between the input rod 7 and the primary piston 40 in Step S92. On the other hand, when the relative displacement amount is equal to or larger than the threshold value, the target position of the primary piston 40 is determined so that the ratio of the movement amount of the primary piston 40 to the movement amount of the input rod 7 becomes equal to the second ratio for reducing the relative displacement amount, which is smaller than the first ratio, in Step S93. Then, in Step S94, the driving current is supplied to the electric motor 20 by the motor driving unit 301 so that the primary piston 40 moves to the target position.

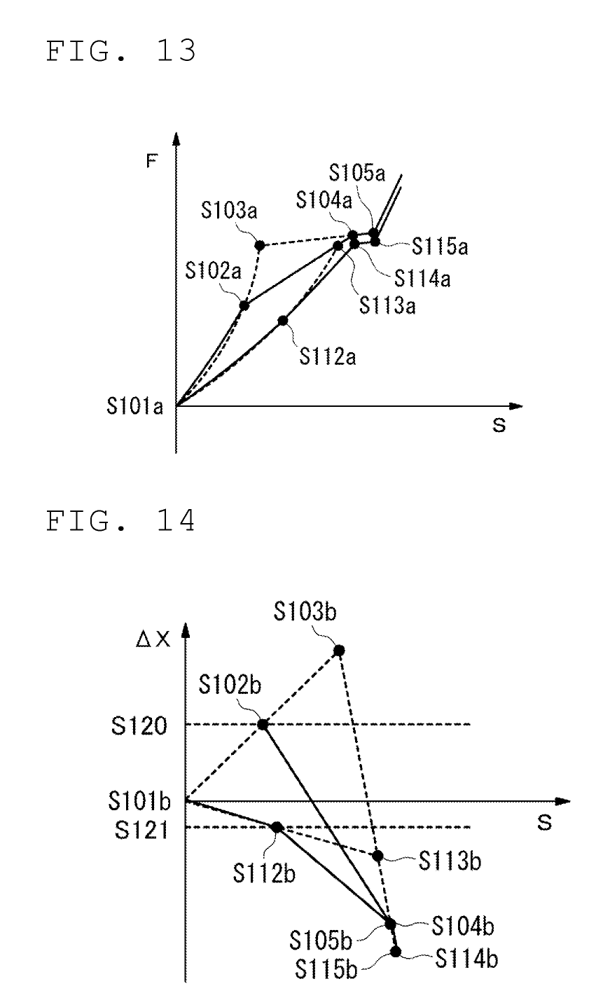

FIG. 13 shows the relationship between the movement amount (stoke; indicated by S in FIG. 13) of the brake pedal 100 and the pedaling force (indicated by F in FIG. 13) on the brake pedal 100 when the control illustrated in FIG. 12 is applied. Referring to a curve from S101a to S105a shown in FIG. 13, when the driver depresses the brake pedal 100 in a state in which the brake pedal 100 is released to be located at a non-braking position S101a (stroke 0), the primary piston 40 moves so that the ratio of the movement amount of the primary piston 40 to the movement amount of the input rod 7 becomes equal to the first ratio. Then, the relative displacement amount between the input rod 7 and the primary piston 40 increases in accordance with the movement amount of the input rod 7. Besides the spring forces of the centering springs 19A and 19B, a reaction force generated by an increase in fluid pressure in the master cylinder 9, acts on the brake pedal 100. As a result, the pedaling force on the brake pedal 100 is increased.

When the relative displacement amount between the input rod 7 and the primary piston 40 reaches a changing point S102a at which the relative displacement amount becomes equal to the threshold value, the ratio of the movement amount of the primary piston 40 to the movement amount of the input rod 7 is changed or switched from the first ratio to the second ratio which is smaller than the first ratio. At this time, a changing point S102a, at which the control is changed or switched, is set so as to be smaller than a first full-load point S103a, at which the movement amount of the primary piston 40 by the electric motor 20 becomes maximum (the output of the electric motor 20 becomes maximum), in the control with the first ratio.

At the changing point S102a, the execution of the control with the second ratio is started. Then, in the control with the second ratio, the movement amount of the brake pedal 100 reaches a second full-load point S104a at which the movement amount of the primary piston 40 by the electric motor 20 becomes maximum (the output of the electric motor 20 becomes maximum). After the second full-load point S104a, the primary piston 40 is stopped and only the input rod 7 moves forward by the pedaling force applied by the driver on the brake pedal 100. At this time, a rate of an increase in pedaling force with respect to the stroke of the brake pedal 100 becomes small. Then, when the input rod 7 moves to the abutment point S105a, the input piston 16 comes into contact with the primary piston 40. After the movement amount of the input rod 7 reaches the abutment point S105a, the primary piston 40 is thrust together with the input rod 7 and the input piston 16 by the pedaling force applied by the driver on the brake pedal 100. Therefore, the rate of increase in pedaling force with respect to the stroke of the brake pedal 100 is increased.

In this manner, by changing the ratio of the movement amount of the primary piston 40 to the movement amount of the input rod 7 from the first ratio to the second ratio smaller than the first ratio, the fluctuation in pedaling force on the brake pedal 100 at the full-load point at which the output of the electric motor 20 becomes maximum and the abutment point at which the input piston 16 comes into contact with the primary piston 40 is reduced to improve the brake-pedal feeling of the brake pedal 100.

The first ratio of the movement amount of the primary piston 40 to the movement amount of the input rod 7 can be appropriately changed by the master-pressure control device 3. In contrast to the above-mentioned curve from S101a to S105a, a curve from S101a to S115a shown in FIG. 13 indicates the relationship between the movement amount of the input rod 7 and the pedaling force on the brake pedal 100 when the first ratio is reduced.

FIG. 14 shows the relationship between the movement amount (indicated by S in FIG. 14) of the brake pedal 100 (that is, the input rod 7) and the relative displacement amount (indicated by ΔX in FIG. 14) between the input rod 7 and the primary piston 40. A characteristic indicated by the curve from S101a to S105a shown in FIG. 13 corresponds to a characteristic indicated by a curve from S101b to S105b shown in FIG. 14, whereas a characteristic indicated by the curve from S101a to S115a shown in FIG. 13 corresponds to a characteristic indicated by a curve from S101b to S115b shown in FIG. 14. Referring to FIG. 14, for example, when the control with the first ratio has the characteristic indicated by the curve from S101b to S105b (the relative displacement amount becomes maximum at the full-load point S103b), which is obtained when the movement amount of the primary piston 40 becomes large with respect to the movement amount of the input rod 7 (advance control), a threshold value S120 of the relative displacement amount, which is smaller than that at the full-load point S103b, is set. In this manner, when the relative displacement amount reaches the threshold value S120, the control is changed or switched to the control with the second ratio for reducing the relative displacement amount, which is smaller than the first ratio. In this manner, the fluctuation in pedaling force on the brake pedal 100 at the second full-load point S104a (see FIG. 13) at which the output of the electric motor 20 becomes maximum and the abutment point S105a (see FIG. 13) at which the input piston 16 comes into contact with the primary piston 40 is reduced to improve the brake-pedal feeling of the brake pedal 100.

On the other hand, when the control with the first ratio has a characteristic indicated by a curve from S101b to S115b (with the full-load point S113b) obtained when the movement amount of the primary piston 40 becomes small with respect to the movement amount of the input rod 7 (delay control), a threshold value 5121 of the relative displacement amount, which has a smaller absolute value than that of the relative displacement amount at the full-load point S113b, is set. In this manner, when the relative displacement amount reaches the threshold value S121, the control is changed or switched to the control with the second ratio for reducing the relative displacement amount (increasing a delay of the primary piston 40 with respect to the input rod 7), which is smaller than the first ratio. As a result, the fluctuation in pedaling force on the brake pedal 100 at the second full-load point S114a (see FIG. 13), at which the output of the electric motor 20 becomes maximum, and the abutment point S115a (see FIG. 13), at which the input piston 16 comes into contact with the primary piston 40, is reduced to improve the brake-pedal feeling of the brake pedal 100.

As described above, by setting the threshold value S120 between the non-braking point S101b and the full-load point S103b and the threshold value S121 between the non-braking point S101b and the full-load point S113b in accordance with the first ratio, the changing from the control with the first ratio to the control with the second ratio can be executed.

In the above-mentioned embodiments, the electric booster includes an input member moved forward and backward by an operation of a brake pedal, a boosting member provided so as be movable relative to the input member, for generating a brake fluid pressure in a master cylinder by forward movement of the boosting member, with which the input member comes into contact by the forward movement of the input member, an electric actuator for driving the boosting member, and a controller for controlling actuation of the electric actuator based on the movement of the input member, and is capable of changing a movement amount of the boosting member with respect to a movement amount of the input member to generate the brake fluid pressure in the master cylinder. In the electric booster, the controller executes changing control for changing a ratio of the movement amount of the boosting member to the movement amount of the input member to a smaller ratio before an output of the electric actuator increases to come into a full-load state in which the output of the electric actuator becomes equal to a maximum output by the forward movement of the input member.

With the configuration described above, a sudden change in reaction force to an operation of a brake pedal can be suppressed so as to improve a brake-pedal feeling.

In the above-mentioned embodiments, the controller controls the actuation of the electric actuator so that the input member comes into contact with the boosting member after the output of the electric actuator increases to come into a full-load state, in which the output of the electric actuator becomes equal to the maximum output, by the forward movement of the input member after the changing control is executed.

In the above-mentioned first embodiment, the controller is configured to execute the changing control when the movement amount of the input member reaches a predetermined threshold value.

In the above-mentioned second embodiment, the controller is configured to execute the changing control when the brake fluid pressure in the master cylinder reaches a predetermined threshold value.

In the above-mentioned fifth embodiment, the controller is configured to execute the changing control when a relative displacement amount between the input member and the boosting member reaches a predetermined threshold value.

In the above-mentioned third embodiment, the controller is configured to execute the changing control when a pedaling force on the brake pedal reaches a predetermined threshold value.

In the above-mentioned fourth embodiment, the controller is configured to execute the changing control when a current value of a current flowing through the electric actuator reaches a predetermined threshold value.

In the above-mentioned embodiments, the controller is configured to control the actuation of the electric actuator so that the movement amount of the boosting member becomes large with respect to the movement amount of the input member before the execution of the changing control and controls the actuation of the electric actuator so that the movement amount of the boosting member becomes small with respect to the movement amount of the input member after the execution of the changing control.

In the above-mentioned embodiments, the controller is configured to execute the changing control only when the brake pedal is operated in a state in which a vehicle is stopped.

With the configuration described above, the boost ratio is increased to some extent while the vehicle is running, whereas the fluctuation in pedaling force on the brake pedal 100 is reduced when the vehicle is in a stop state or immediately before the vehicle is stopped. In this manner, the brake-pedal feeling of the brake pedal 100 can be improved.

According to the electric booster of the above-mentioned embodiments, a sudden change in reaction force to an operation of a brake pedal can be suppressed so as to improve a brake-pedal feeling.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Application No. 2011-165549 filed on Jul. 28, 2011. The entire disclosure of Japanese Patent Application No. 2011-165549 filed on Jul. 28, 2011 including specification, claims, drawings and summary is incorporated herein by reference in its entirety.

What is claimed is:

1. An electric booster, comprising:
an input member moved forward and backward by an operation of a brake pedal;
a boosting member provided so as to be movable relative to the input member, for generating a brake fluid pressure in a master cylinder by forward movement, with which the input member comes into contact by the forward movement of the input member;
an electric actuator for driving the boosting member; and
a controller for controlling actuation of the electric actuator based on the movement of the input member, wherein:
a movement amount of the boosting member changes with respect to a movement amount of the input member so that the boosting member can generate the brake fluid pressure in the master cylinder; and
the controller executes changing control for changing a ratio of the movement amount of the boosting member to the movement amount of the input member to a smaller ratio before an output of the electric actuator increases to come into a full-load state in which the output of the electric actuator becomes equal to a maximum output by the forward movement of the input member.

2. An electric booster according to claim 1, wherein the controller controls the actuation of the electric actuator so that the input member comes into contact with the boosting member when or after the output of the electric actuator increases to come into the full-load state, in which the output of the electric actuator becomes equal to the maximum output in the control after the changing, by the forward movement of the input member after the changing control is executed.

3. An electric booster according to claim 1, wherein the controller executes the changing control when the movement amount of the input member reaches a predetermined threshold value or when the movement amount of the boosting member reaches a predetermined threshold value.

4. An electric booster according to claim 1, wherein the controller executes the changing control when the brake fluid pressure in the master cylinder reaches a predetermined threshold value.

5. An electric booster according to claim 1, wherein the controller controls the electric actuator in accordance with the forward movement of the input member so that a ratio of the movement amount of the boosting member to the movement amount of the input member becomes larger than 1 before the execution of the changing control, and executes the changing control when a relative displacement amount between the input member and the boosting member reaches a predetermined threshold value.

6. An electric booster according to claim 1, wherein the controller executes the changing control when a pedaling force on the brake pedal reaches a predetermined threshold value.

7. An electric booster according to claim 1, wherein the controller executes the changing control when a current value of a current flowing through the electric actuator reaches a predetermined threshold value.

8. An electric booster according to claim 1, wherein the controller controls the actuation of the electric actuator so that the movement amount of the boosting member becomes large with respect to the movement amount of the input member before the execution of the changing control, and controls the actuation of the electric actuator so that the movement amount of the boosting member becomes small with respect to the movement amount of the input member after the execution of the changing control.

9. An electric booster according to claim 1, wherein the controller executes the changing control only when the brake pedal is operated in a state in which a vehicle is stopped.

10. An electric booster, comprising:
a boosting member provided so as to be movable relative to an input member moved forward and backward by an operation of a brake pedal, for generating a brake fluid pressure in a master cylinder by the movement of the boosting member;
an electric actuator for driving the boosting member; and
a controller for controlling actuation of the electric actuator based on the movement of the input member, wherein:
the boosting member is configured so that the input member comes into contact with the boosting member when the electric actuator is not actuated by the control of the controller; and
the controller controls the electric actuator in accordance with the forward movement of the input member so that a ratio of a movement amount of the boosting member to a movement amount of the input member becomes larger than 1, and executes changing control for changing the ratio of the movement amount of the boosting member to the movement amount of the input member to a smaller ratio before the electric actuator comes into a full-load state in which the electric actuator generates a maximum output.

11. An electric booster according to claim 10, wherein the controller controls the actuation of the electric actuator so that the input member comes into contact with the boosting member when or after an output of the electric actuator increases to come into the full-load state, in which the output of the electric actuator becomes equal to the maximum output in the control after the changing, by the forward movement of the input member after the changing control is executed.

12. An electric booster according to claim 10, wherein the controller executes the changing control when the movement amount of the input member reaches a predetermined threshold value or when the movement amount of the boosting member reaches a predetermined threshold value.

13. An electric booster according to claim 10, wherein the controller executes the changing control when a relative displacement amount between the input member and the boosting member reaches a predetermined threshold value.

14. An electric booster according to claim 10, wherein the controller executes the changing control when a current value of a current flowing through the electric actuator reaches a predetermined threshold value.

15. An electric booster according to claim 10, wherein the controller executes the changing control only when the brake pedal is operated in a state in which a vehicle is stopped.

16. An electric booster, comprising:
a boosting member provided so as to be movable relative to an input member moved forward and backward by an operation of a brake pedal provided to a vehicle, for generating a brake fluid pressure in a master cylinder by the movement of the boosting member; and
a controller for controlling an electric actuator for driving the boosting member based on the movement of the input member, wherein:
the boosting member is configured so that the input member comes into contact with the boosting member when the electric actuator is not actuated by the control of the controller; and
when the brake pedal is operated in a state in which the vehicle is stopped, the controller controls the electric actuator in accordance with the forward movement of the input member so that a ratio of a movement amount of the boosting member to a movement amount of the input member becomes larger than 1, and executes changing control for changing the ratio of the movement amount of the boosting member to the movement amount of the input member to a smaller ratio before the electric actuator comes into a full-load state in which the electric actuator generates a maximum output.

17. An electric booster according to claim 16, wherein the controller controls the actuation of the electric actuator so that the input member comes into contact with the boosting member when or after an output of the electric actuator increases to come into the full-load state, in which the output of the electric actuator becomes equal to the maximum output in the control after the changing, by the forward movement of the input member after the changing control is executed.

18. An electric booster according to claim 16, wherein the controller executes the changing control when the movement amount of the input member reaches a predetermined threshold value or when the movement amount of the boosting member reaches a predetermined threshold value.

19. An electric booster according to claim 16, wherein the controller executes the changing control when a relative displacement amount between the input member and the boosting member reaches a predetermined threshold value.

20. An electric booster according to claim 16, wherein the controller executes the changing control when a current value of a current flowing through the electric actuator reaches a predetermined threshold value.
